(19) United States
(12) Patent Application Publication
(10) Pub. No.: US 2023/0262811 A1
(43) Pub. Date: Aug. 17, 2023

(54) METHODS, DEVICES, AND SYSTEMS FOR COORDINATING MULTIPLE NETWORKS IN DUAL-ACTIVE STATE

(71) Applicant: ZTE Corporation, Shenzhen (CN)

(72) Inventors: Wenting LI, Shenzhen (CN); He HUANG, Shenzhen (CN)

(73) Assignee: ZTE Corporation, Shenzhen (CN)

(21) Appl. No.: 18/135,831

(22) Filed: Apr. 18, 2023

Related U.S. Application Data
(63) Continuation of application No. PCT/CN2021/071872, filed on Jan. 14, 2021.

(51) Int. Cl. H04W 76/16; H04W 24/10

(52) U.S. Cl. CPC H04W 76/16; H04W 24/10

(57) ABSTRACT

The present disclosure describes methods, systems, and devices for coordinating multiple networks in dual-active state. One method includes coordinating, by a user equipment (UE), multiple networks comprising a first network and a second network. Another method includes coordinating, by a network, multiple networks connecting with a UE by: determining, by the network, configuration parameters or capability restriction; and sending, by the network, the configuration parameters or capability restriction to the UE, the multiple networks comprising a first network and a second network.

### TECHNICAL FIELD

The present disclosure is directed generally to wireless communications. Particularly, the present disclosure relates to methods, devices, and systems for coordinating multiple networks in dual-active state.

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

For the 5th Generation (5G) mobile communication technology, a user equipment (UE), for example, a smart phone, may register with and connect to more than one network nodes at the same time.

The present disclosure may address at least some of issues/problems associated with the existing system and describes various embodiments for coordinating multiple networks, improving the performance of the wireless communication.

### SUMMARY

This document relates to methods, systems, and devices for wireless communication, and more specifically, for coordinating multiple networks in dual-active state.

In one embodiment, the present disclosure describes a method for wireless communication. The method includes coordinating, by a user equipment (UE), multiple networks comprising a first network and a second network, wherein the UE coordinates the multiple networks with at least one of the following items: a band combination (BC) capability coordination, a power control coordination, a capability coordination, or a measurement coordination.

In another embodiment, the present disclosure describes a method for wireless communication. The method includes coordinating, by a network, multiple networks connecting with a user equipment (UE) by: determining, by the network, configuration parameters or capability restriction; and sending, by the network, the configuration parameters or capability restriction to the UE, the multiple networks comprising a first network and a second network.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1 shows an example of a wireless communication system include more than one network nodes and one or more user equipment.

FIG. 2 shows an example of a network node.

FIG. 3 shows an example of a user equipment.

FIG. 4 shows a flow diagram of a method for wireless communication.

FIG. 5 shows a flow diagram of a method for wireless communication.

FIG. 6 shows a schematic diagram of an exemplary embodiment for wireless communication.

FIG. 7 shows a schematic diagram of an exemplary embodiment for wireless communication.

FIG. 8 shows a schematic diagram of an exemplary embodiment for wireless communication.

FIG. 9 shows a schematic diagram of an exemplary embodiment for wireless communication.

FIG. 10 shows a schematic diagram of an exemplary embodiment for wireless communication.

FIG. 11 shows a schematic diagram of an exemplary embodiment for wireless communication.

FIG. 12 shows a schematic diagram of an exemplary embodiment for wireless communication.

FIG. 13 shows a schematic diagram of an exemplary embodiment for wireless communication.

FIG. 14 shows a schematic diagram of an exemplary embodiment for wireless communication.

FIG. 15 shows a schematic diagram of an exemplary embodiment for wireless communication.

FIG. 16 shows a schematic diagram of an exemplary embodiment for wireless communication.

FIG. 17 shows a schematic diagram of an exemplary embodiment for wireless communication.

FIG. 18 shows a schematic diagram of an exemplary embodiment for wireless communication.

FIG. 19 shows a schematic diagram of an exemplary embodiment for wireless communication.

FIG. 20 shows a schematic diagram of an exemplary embodiment for wireless communication.

FIG. 21 shows a schematic diagram of an exemplary embodiment for wireless communication.

FIG. 22 shows a schematic diagram of an exemplary embodiment for wireless communication.

FIG. 23 shows a schematic diagram of an exemplary embodiment for wireless communication.

FIG. 24 shows a schematic diagram of an exemplary embodiment for wireless communication.

FIG. 25 shows a schematic diagram of an exemplary embodiment for wireless communication.

FIG. 26 shows a schematic diagram of an exemplary embodiment for wireless communication.

FIG. 27 shows a schematic diagram of an exemplary embodiment for wireless communication.

FIG. 28 shows a schematic diagram of an exemplary embodiment for wireless communication.

FIG. 29 shows a schematic diagram of an exemplary embodiment for wireless communication.

FIG. 30 shows a schematic diagram of an exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for coordinating multiple networks in dual-active state.

New generation (NG) mobile communication system are moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfill the requirements from different industries and users.

The present disclosure describes various embodiments for coordinating multiple networks in dual-active state. Under one or more scenarios, a user equipment (UE) may connect to more than one network nodes at the same time. The network nodes, for example, may include one or more radio access network (RAN) node and/or one or more core network (CN) node. In one implementation, the UE may connect with two network nodes at the same time, which may be referred as “dual-active state”, which need the UE and/or one or more network nodes to coordinate the multiple connections, so as to provide an efficient system for the one or more scenarios.

One scenario may include that, for a UE having multiple subscriber identity modules (Multi-SIMs), the UE may connect with the multiple networks at the same time. In another scenario, a UE with a single SIM may connect with the multiple networks at the same time. Another scenario may include, a roaming UE may connect multiple networks for different slices. Another scenario may include, Video, Imaging and Audio for Professional Applications (VIAPA) may require to enable a UE to receive data services from one network, for example but not limited to, a non-public network (NPN), and to simultaneously receive paging and/or data services from another network, for example but not limited to, a public land mobile network (PLMN). The VIAPA scenario may be similar to the Multi-SIM scenario. As an enhancement on the slice, the 5G system may enable a roaming UE to access network slices from more than one VPLMN simultaneously, which means the UE may connect to the more than one networks simultaneously, which is similar to the Multi-SIM scenario.

The UE and/or one or more network nodes need to coordinate the multiple connections, so as to provide an efficient system for various scenarios. However, the details of how to coordinate multiple networks by the UE and/or the one or more network nodes remain unclear, which hinders an efficient wireless communication system.

The present disclosure describes various embodiments for coordinating multiple networks by the UE and/or the one or more network nodes, addressing at least some of issues/problems associated with the existing system, providing solutions to at least some of the problems, and/or improving the performance of the wireless communication.

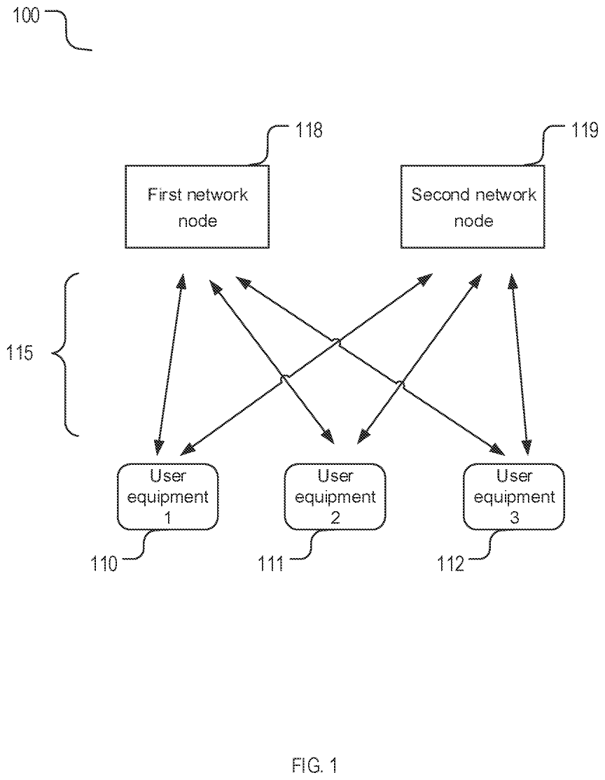

FIG. 1 shows a wireless communication system 100 including more than one wireless network nodes (118 and 119) and one or more user equipment (UE) (110, 111, and 112).

For the 5th Generation mobile communication technology, a UE 110, for example, a smart phone, may have a single subscriber identity module (SIM) or multiple subscriber identity modules (Multi-SIMs). When the UE has a single SIM, the UE may connect to one network node 118, for example, a radio access network (RAN) node and/or a core network (CN) node, or may connect to more than one network nodes (118 and 119), for example, two RAN nodes and/or two CN nodes. When the UE has Multi-SIMs, the UE may connect to more than one network nodes (118 and 119), for example, two RAN nodes, two CN nodes, and/or one RAN node and one CN node.

The wireless network node (118 and 119) may include a network base station, which may be a nodeB (NB, e.g., a gNB) in a mobile telecommunications context. Each of the UE (110, 111, and/or 112) may wirelessly communicate with the wireless network node (118 and/or 119) via one or more radio channels 115. For example, the first UE 110 may wirelessly communicate with the first network node 118 via a channel including a plurality of radio channels during a certain period of time; during another period of time or simultaneously at the same time, the first UE 110 may wirelessly communicate with the second network node 119 via a channel including a plurality of radio channels.

The present disclosure describes various embodiments for coordinating multiple network in dual-active state for at least one scenario, including but not limited to the scenarios as discussed above. The present disclosure describes methods, systems, and storage medium of how the UE and/or one or more network nodes coordinate the multiple connections between the UE and the multiple network nodes.

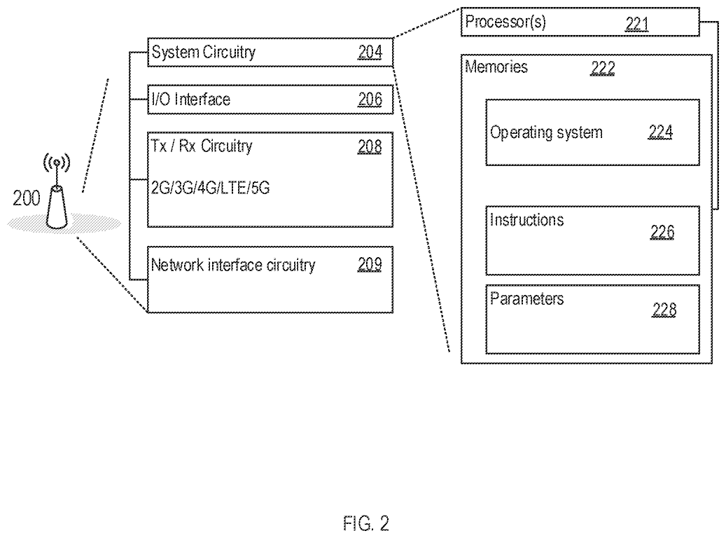

FIG. 2 shows an example of electronic device 200 to implement a network node or network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

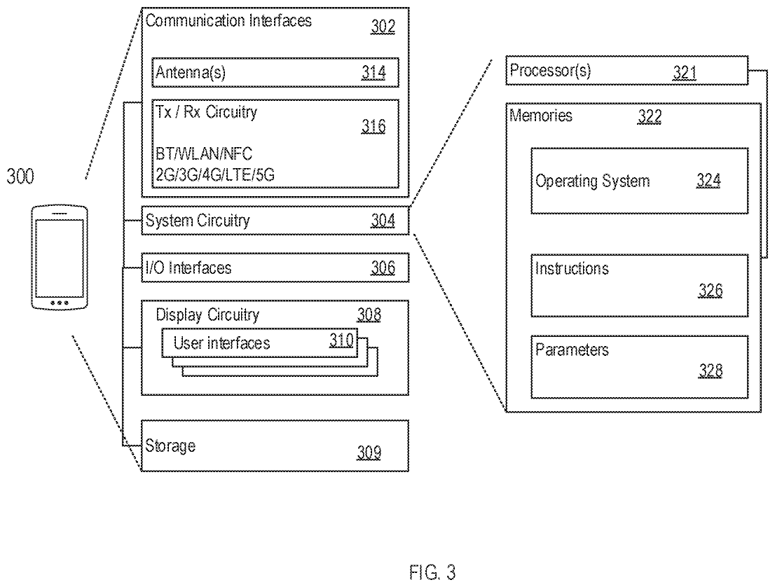

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAG, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

The present disclosure describes several below embodiments, which may be implemented, partly or totally, on the network base station and/or the user equipment described above in FIGS. 2-3.

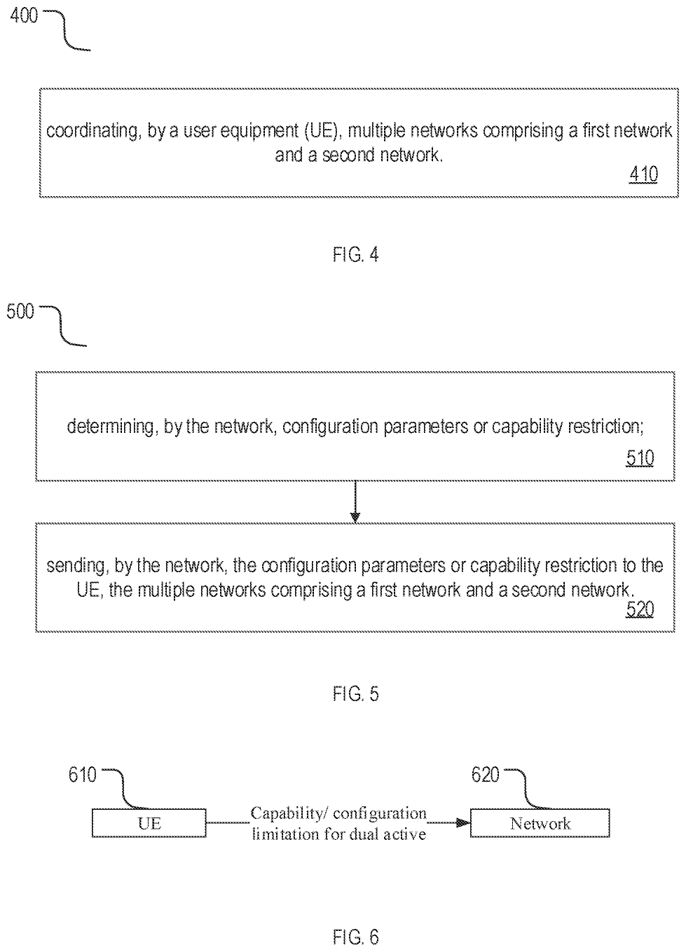

Referring to FIG. 4, the present disclosure describes embodiments of a method 400 for wireless communication. The method 400 may include a portion or all of the following steps: step 410: coordinating, by a user equipment (UE), multiple networks comprising a first network and a second network. In one implementation, the UE comprises multiple subscriber identification modules (Multi-SIMs) connecting with the multiple networks. In another implementation, the UE is in a roaming state connecting with the multiple networks for different slices. In another implementation, the UE has a video, imaging, and audio for professional application (VIAPA) connecting with the multiple networks.

Referring to FIG. 5, the present disclosure describes embodiments of a method 500 for coordinating, by a network, multiple networks connecting with a user equipment (UE). The method 500 may include a portion or all of the following steps: step 510: determining, by the network, configuration parameters or capability restriction; and step 520: sending, by the network, the configuration parameters or capability restriction to the UE, the multiple networks comprising a first network and a second network.

Without limitation to the present disclosure, the various embodiments described below may use a UE with the Multi-SIMs. These embodiments are examples and do not limit the present disclosure, and the present disclosure may also be applied to the other scenarios that a UE connect to the two networks simultaneously.

Below, the present disclosure describes at least, the condition of entering into the dual-active state, one or more capability/configuration that need to be coordinated, procedures of coordinating capability/configuration before entering into the connected state, procedures of re-negotiating capability/configuration between multiple networks through the UE, one or more examples and descriptions on the band combination coordination and/or measurement coordination (for example, discontinuous reception (DRX) coordination).

### Dual-Active State Capability/Configuration Coordination Conditions

The present disclosure present various embodiments, wherein before the UE connects with the multiple networks, the UE performs a configuration based on at least one supported band combination (BC) by the UE. In one implementation, in response to the UE connecting with the first network on a first frequency, the UE wanting to connect with the second network on a second frequency, and the UE not supporting a BC of the first frequency and the second frequency: the configuration comprises at least one of the following: the UE releases a connection with the first network, the UE changes the UE to a third frequency with the first network in response to the at least one supported BC comprising a BC of the second frequency and the third frequency, or the UE establishes a connection on the third frequency with the second network in response to the at least one supported BC comprising a BC of the first frequency and the third frequency.

In another implementation, in response to the UE being at a dual connection (DC) with the first network and the UE wanting to connect with the second network, the UE indicates the first network to release a second cell group (SCG).

For one example, for the UE that may connect to the 2 networks simultaneously, because of the UE capability limitation, the UE need to take the supported Band Combination (BC) into consideration. The BC indicates the band(s) and the corresponding feature sets that the UE can works simultaneously. For example, the UE was work at the connected state with network A on the frequency f1. When the UE wants to establish the connection with the network B on the frequency f2, but the radio frequency (RF) doesn't support the corresponding Band Combinations (i.e., a BC with f1 and f2 is not supported), the UE may have at least one of the following solutions: release the connection (e.g., trigger leaving procedure) with network A; change the UE to the frequency f3 with the network A if the UE support a BC of f2+f3; and/or try to establish the connection on the frequency f3 with the network B if the UE support a BC of f1+f3.

For another example, for a UE at the Dual Connection (DC) state with the network A, when the UE wants to establish the connection with the network B, the UE may need to indicate the Network A to release a second cell group (SCG).

### Dual-Active State Capability/Configuration Coordination Items

The present disclosure describes various embodiments, wherein the UE coordinates the multiple networks with at least one of the following items: a BC capability coordination, a power control coordination, a capability coordination, or a measurement coordination. In one implementation, the BC capability coordination comprises at least one of the following: a set of band combinations, or a feature set.

In another implementation, the feature set mainly comprises baseband and RF capabilities, the feature set comprising at least one of the following: at least one feature set combination, at least one per feature set capability, or at least one per component carrier (CC) per feature set capabilities.

In another implementation, the BC capability may include the following capabilities:

```
BandCombination ::=  SEQUENCE {
    bandList  SEQUENCE (SIZE
(1 .. maxSimultaneousBands)) OF BandParameters,
    featureSetCombination  FeatureSetCombinationId,
    ca-ParametersEUTRA  OPTIONAL,
    ca-ParametersNR  OPTIONAL,
    mrdc-Parameters  OPTIONAL,
    supportedBandwidthCombinationSet   BIT STRING (SIZE (1 .. 32))
OPTIONAL,
    powerClass-v1530  ENUMERATED {pc2}
OPTIONAL}
```

In another implementation, the feature set capability may be expressed by the FeatureSetCombination or the entries of the FeatureSetCombination, which is a two-dimensional matrix of FeatureSet entries.

In another implementation, each FeatureSetsPerBand contains a list of feature sets applicable to the carrier(s) of one band entry of the associated band combination. Across the associated bands, the UE may support the combination of FeatureSets at the same position in the FeatureSetsPerBand. In another implementation, all FeatureSetsPerBand in one FeatureSetCombination must have the same number of entries.

In another implementation, the number of FeatureSetsPerBand in the FeatureSetCombination must be equal to the number of band entries in an associated band combination. The first FeatureSetPerBand applies to the first band entry of the band combination, and so on. In another implementation, the featureset capability may include the following:

| | |
|---|---|
| FeatureSetCombination ::= | SEQUENCE (SIZE (1 .. maxSimultaneousBands)) |
| OF FeatureSetsPerBand | |
| FeatureSetsPerBand ::= | SEQUENCE (SIZE (1 .. maxFeatureSetsPerBand)) |
| OF FeatureSet | |
| FeatureSet ::= | CHOICE { |
| eutra | SEQUENCE { |
| downlink SetEUTRA | FeatureSetEUTRA-DownlinkId, |
| uplinkSetEUTRA | FeatureSetEUTRA-UplinkId |
| }, | |
| nr | SEQUENCE { |
| downlink SetNR | FeatureSetDownlinkId, |
| uplinkSetNR | FeatureSetUplinkId |
| } | |
| } | |

In another implementation, the set of band combinations comprises at least one of the following: a band information, a bandwidth class information, or at least one per band combination parameter.

In another implementation, the power control coordination comprises at least one of the following: a maximum power of each network, or a maximum power of each frequency range.

In another implementation, the capability coordination comprises at least one of the following: a maximum number of robust header compression (ROHC), a maximum number of Ethernet header compression (EHC), or a number of blind detections supported.

In another implementation, the measurement coordination comprises at least one of the following: a measurement gap configuration, at least one measured frequency, a maximum number of inter-frequency carriers allowed to configure, a maximum number of allowed measurement identities allowed to configure for intra-frequency measurement on each serving frequency, or a maximum number of allowed measurement identities allowed to configure for inter-frequency measurement.

In another implementation, the measurement gap configuration comprises at least one of the following: a per UE measurement gap configuration, or a per frequency measurement gap configuration.

For one example, the capabilities and the configurations that need to be coordination among two or more networks by the UE including but not limited to the following items.

BC capability coordination includes band combinations, and the related feature set. The feature set mainly indicates the baseband and RF capabilities, and the Band combinations includes the band information, bandwidth class information, and other per band combination parameters.

Power control coordination includes the maximum power of each network, the maximum power of each frequency range.

Other capabilities include at least one of the max number of ROHC/max number of EHC/pdcch-BlindDetection: max number of ROHC includes the maximum number of ROHC header compression context sessions; max number of EHC includes the maximum number of Ethernet header compression contexts across all DRBs and across EHC compressor and EHC decompressor; pdcch-BlindDetection includes the number of blind detections supported.

Measurement coordination includes at least one of the measurement Gap configuration; the measured frequencies; maxMeasFreqs indicating the maximum number of inter-frequency carriers allowed to configure; maxIntraFreqMeasIdentities indicating the maximum number of allowed measurement identities allowed to configure for intra-frequency measurement on each serving frequency; and/or maxInterFreqMeasIdentities indicating the maximum number of allowed measurement identities allowed to configure for inter-frequency measurement.

Capability/Configuration Coordination Methods Before Entering into Dual-Active State

The present disclosure describes various embodiments, wherein the UE determines a set of configuration parameters or capability restriction for coordinating the multiple network; and the UE sends the set of configuration parameters or capability restriction to the multiple network. In one implementation, the UE receives from the first network a set of configuration parameters or capability restriction for coordinating the multiple network; and the UE sends the set of configuration parameters or capability restriction to the second network.

In another implementation, the UE receives from the first network a first set of configuration parameters or capability restriction for coordinating the multiple network; the UE determines a second set of configuration parameters or capability restriction based on the first set of configuration parameters or capability restriction; and the UE sends the second set of configuration parameters or capability restriction to the second network.

For one example, when the UE support the BC including the frequency of the network A and the frequency of the network B, the UE need to execute dual-active state capability/configuration coordination. Under the scenario that the UE is at connected state with network A and wants to trigger the connection with the network B, generally, there may be several methods for coordinating the connections, including two main methods: the UE determines the capability/configuration limitation and sends it to the network; and the network A determines the capability/configuration limitation and sends it to the UE, then the UE further sends it to the network B.

There are many other methods to achieve this, for example, a combination of partial methods as the two main methods discussed above. For example, Network A determines the capability/configuration limitation and sends it to the UE; the UE further determines the capability/configuration limitation, then sends it to the network B. For another example, the UE determines the capability/configuration limitation and sends it to the network A; the network A configures the UE according to the limitation and further determines the limitation for the network B; the network A sends the limitation for the network B to the UE, the UE may or may not change the limitation and then sends it to the network B.

With limitation, the present disclosure may describes the two main methods as discussed above.

In one implementation, referring to FIG. 6, the UE 610 determines the capability/configuration limitation for dual-active state and sends it to the network 620.

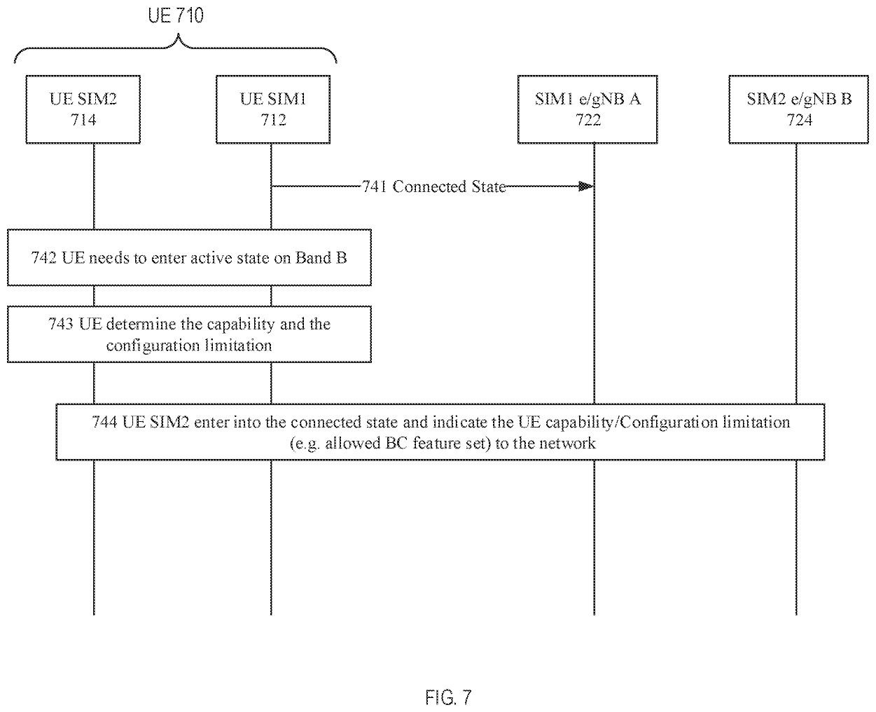

In another implementation, referring to FIG. 7, the UE 710 determines the capability/configuration limitation and sends it to the network B 724. The UE 710 may include a UE SIM1 712 and a UE SIM2 714.

In step 741, the UE SIM1 may be in a connected state with network A (SIM1 e/gNB A 722).

In step 742, the UE needs to enter active state on band B.

In step 743, the UE determines the capability and the configuration limitation for network B (SIM2 e/gNB B 724).

In step 744, the UE SIM2 enter into the connected state and indicate the UE capability/Configuration limitation (e.g., allowed BC feature set) to the network B.

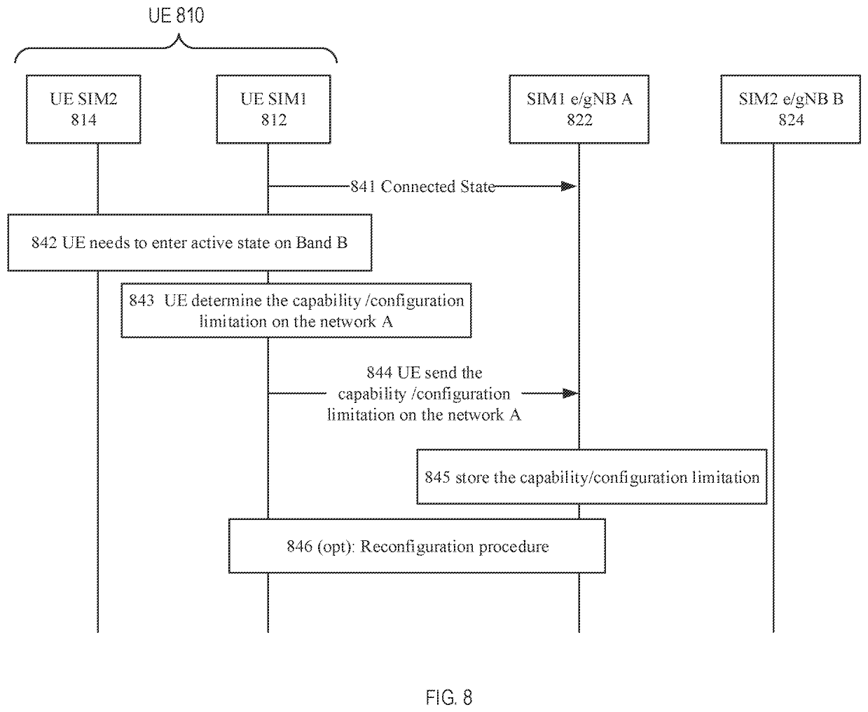

In another implementation, referring to FIG. 8, the UE 810 determines the capability/configuration limitation and sends it to the network A 822. The UE 810 may include a UE SIM1 812 and a UE SIM2 814. The network A may be SIM1 e/gNB A 822. The network B may be a SIM2 e/gNB B 824.

In step 841, the UE SIM1 may be in a connected state with network A.

In step 842, the UE needs to enter active state on band B.

In step 843, the UE determines the capability and the configuration limitation for network A.

In step 844, the UE sends the capability and the configuration limitation for network A to network A.

In step 845, the network A stores capability and the configuration limitation for network A.

In step 846, optionally, the UE and/or the network A may perform reconfiguration procedure.

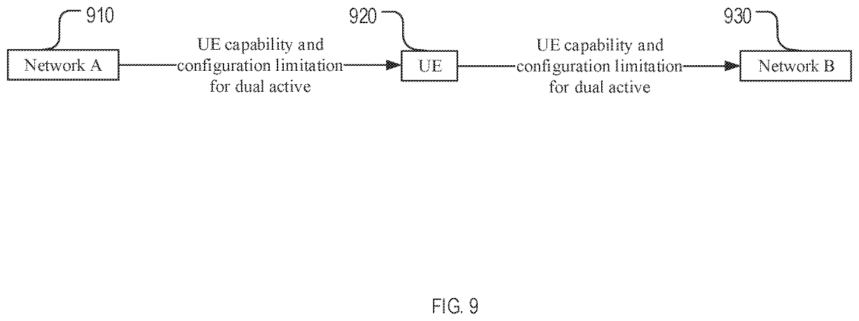

In another implementation, referring to FIG. 9, the network A 910 determines the capability/configuration limitation and sends to the UE 920. The UE sends the capability/configuration limitation to the network B 930.

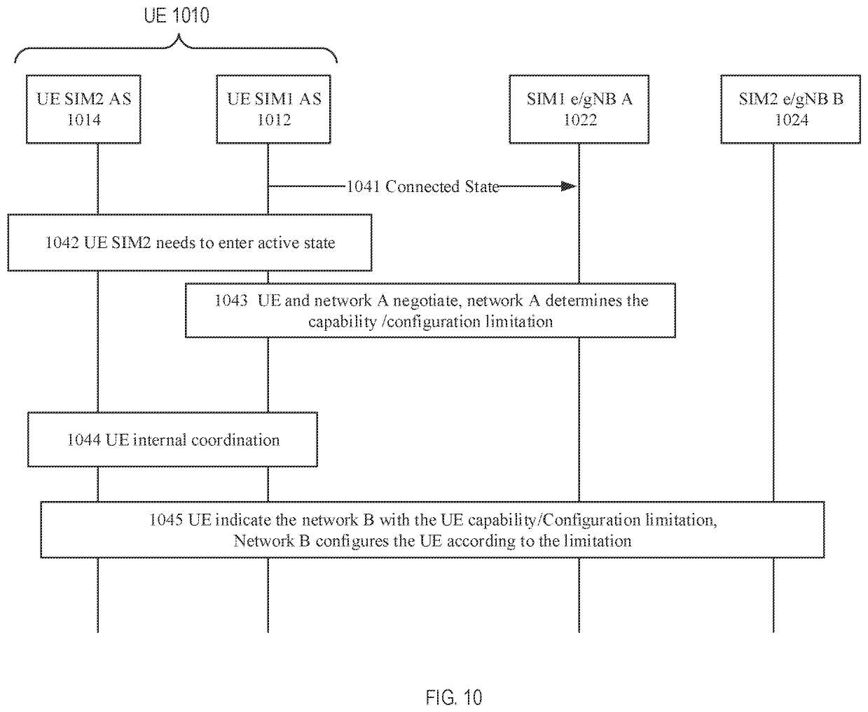

In another implementation, referring to FIG. 10, the network A negotiates and determines the capability/configuration limitation and sends it to the UE, then the UE further sends it to the network B. The UE 1010 may include a SIM1 access stratum (AS) 1012 and a SIM2 AS 1014. The network A may be SIM1 e/gNB A 1022. The network B may be a SIM2 e/gNB B 1024.

In step 1041, the UE SIM1 may be in a connected state with network A.

In step 1042, the UE SIM2 needs to enter active state.

In step 1043, the UE and network A negotiates and the network A determines the capability and the configuration limitation.

In step 1044, the UE performs internal coordination.

In step 1045, the UE indicates the network B with the UE capability/Configuration limitation, and the network B configures the UE according to the limitation.

Some other implementation may be a combination of any or all of the above implementations. In some implementations, at the network Side, the network shall store the capability/configuration limitation.

### Capability/Configuration Re-Negotiation Methods

For one example, for the case that the Network B can't accept the capability/configuration limitation, the network B may renegotiate the capability/configuration limitation by sending the preferred capability/configuration limitation to the UE. The UE can make decision by itself or negotiate with the network A.

The present disclosure describes various embodiments, wherein the UE renegotiates a set of configuration parameters or capability restriction for coordinating the multiple network in response to at least one of the following conditions: one of the multiple networks is unable to implement the set of the configuration parameters or capability restriction, or one of the multiple networks needs to modify the set of configuration parameters or capability restriction in response to an event occurring.

In one implementation, the event comprises at least one of the following: a handover process, a pcell change, or a quality of service (QoS) requirement.

In another implementation, the UE receives from the first network one of the following: a configuration parameters or a capability restriction, or a selected set of configuration parameters.

In another implementation, the UE performs one of the following: sending an acceptance indication to the first network, sending a partial acceptance indication to the first network, or sending a rejection indication to the first network.

In another implementation, in response to sending the partial acceptance indication, the UE sends an updated set of configuration parameters or capability restriction to the first network.

In another implementation, the UE updates the set of configuration parameters or capability restriction; and the UE sends the updated set of configuration parameters or capability restriction to the second network.

In another implementation, the UE sends to the second network one of the configuration parameters, the capability restriction, or the selected set of configuration parameters, so that the second network determines whether to accept the preferred range of configuration parameters or the selected set of configuration parameters.

In another implementation, in response to an acceptance by the second network, the UE receives an accepted set of configuration parameters or capability restriction.

In another implementation, in response to a partial acceptance by the second network, the UE receives an updated set of configuration parameters or capability restriction from the second network.

In another implementation, in response to a rejection by the second network, the UE receives the rejection from the second network.

In another implementation, the UE forwards a negotiation result to the first network.

For one example, for the dual active state, the network may need to renegotiate the capability/configuration limitation, it may happened for at least one of the following cases: the network can't access the capability/configuration limitation; and/or the network need to modify the configuration, e.g., handover, pcell change, QoS requirement.

For another example, the re-negotiation methods may include at least one of the following: The network A send the preferred capability/configuration limitation to the UE; and/or the network A send the selected configuration to the UE,

In various embodiments, at the UE side, upon receiving the preferred capability/configuration limitation or the selected configuration from network A, the UE may make decision by itself, including that the UE can feedback an accept/partially accept/reject indication to the network A. For the partially accept, the UE sends updated capability/configuration limitation to the network A. The UE may update the capability/configuration limitation for the network B and sends it to the network B.

In various embodiments, at the UE side, upon receiving the preferred capability/configuration limitation or the selected configuration from network A, the UE may negotiate with the network B. The UE sends the preferred capability/configuration limitation or the selected configuration to the network B, and/or the network B determines whether the preferred capability/configuration limitation or the selected configuration can be accepted. If it can be accepted, the network B sends accept to the UE. The network B may update the configuration of the UE. If it can be partial accepted, the network B sends the updated capability/configuration limitation to the UE. If it can't be accepted, the network B sends reject to the UE.

In other implementation, the UE forwards the negotiation result to the network A, accept or partial accept or reject.

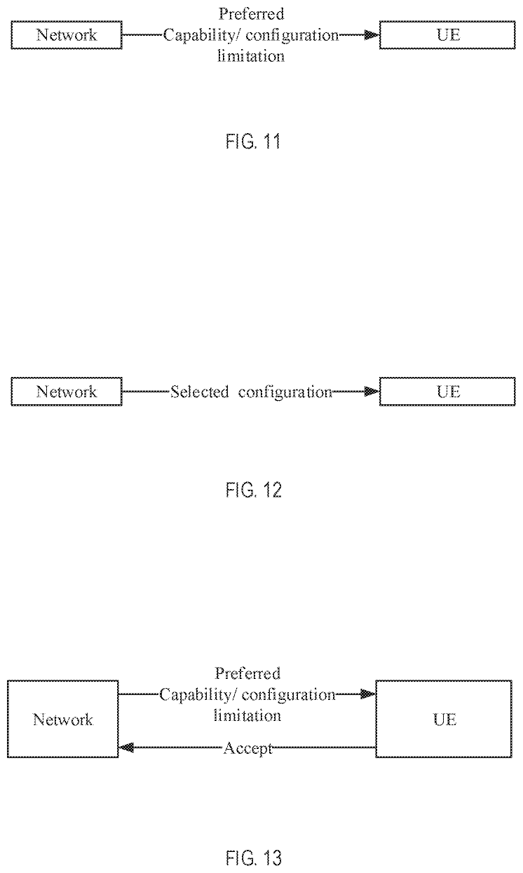

For one example, referring to FIG. 11, the network A sends the preferred capability/configuration limitation to the UE.

For another example, referring to FIG. 12, the network A sends the selected configuration limitation to the UE.

For another example, referring to FIG. 13, the UE makes decision by itself.

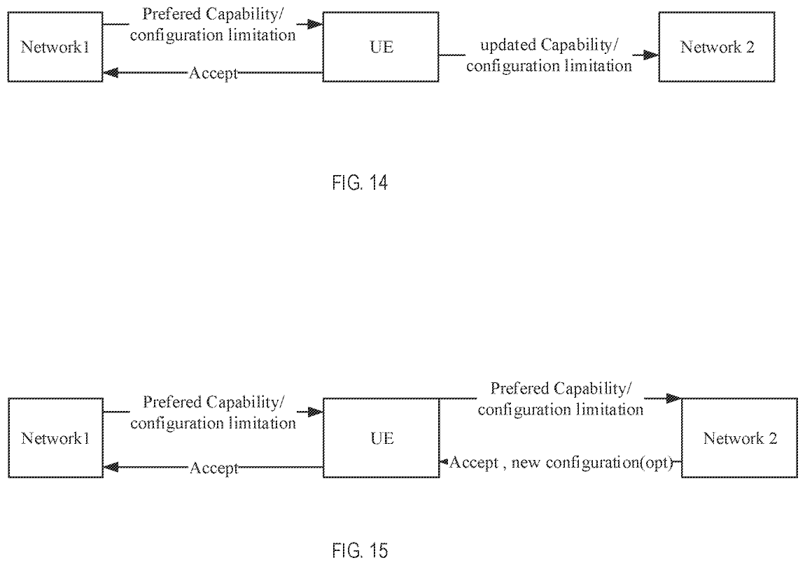

For another example, referring to FIG. 14, the UE makes decision by itself.

For another example, referring to FIG. 15, the UE further negotiates with network with acceptance

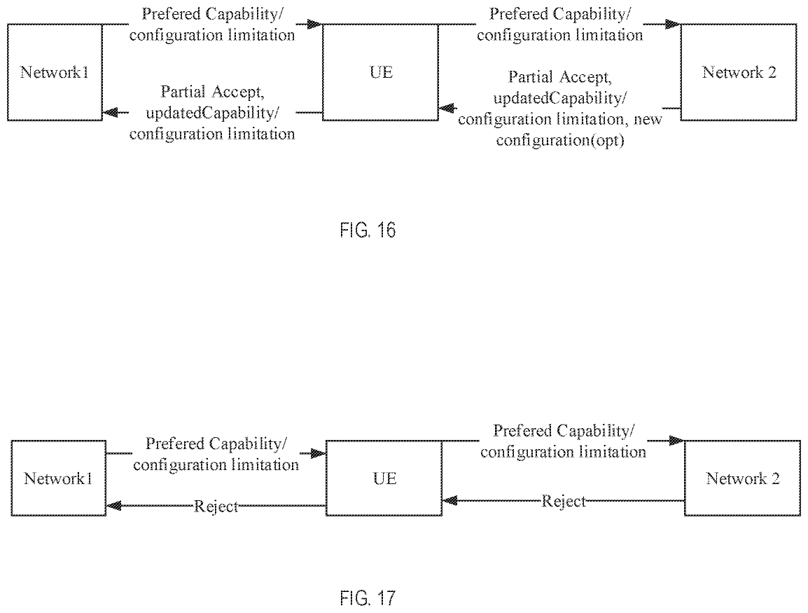

For another example, referring to FIG. 16, the UE further negotiates with network with partial acceptance.

For another example, referring to FIG. 17, the UE further negotiates with network with rejection.

### Capability/Configuration Limitation Revoking for the Release

The present disclosure describes various embodiments, wherein in response to releasing the connection with the first network, the UE sends an assistance information to the second network to revoke a restriction associated with multiple networks connection. In one implementation, the restriction comprises at least one of the following: a capability restriction, or a configuration restriction.

In various embodiments, for the dual-active state, once one USIM has released the connection, the capability/configuration limitation information on the other USIM is not required. Thus, the UE may send the assistance information to the network, the network revoke the capability/configuration limitation.

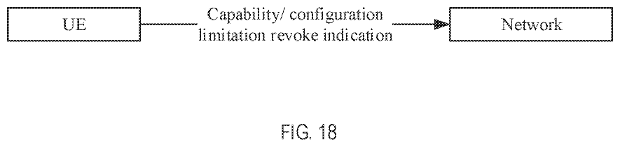

For one example, referring to FIG. 18, the UE sends the capability/configuration limitation revoke indication to the network.

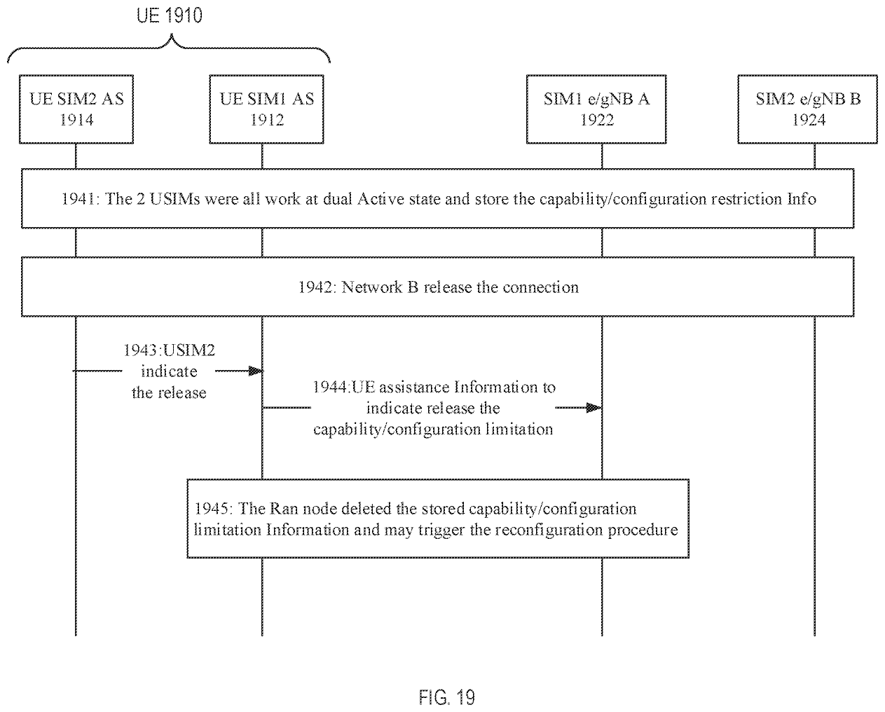

FIG. 19 describes a flow schematic diagram for revoking procedure for capability/configuration limitation. The UE 1910 may include a SIM1 access stratum (AS) 1912 and a SIM2 AS 1914. The network A may be SIM1 e/gNB A 1922. The network B may be a SIM2 e/gNB B 1924.

In step 1941, the 2 USIMs all work at dual-active state and store the capability/configuration limitation Info.

In step 1942, the Network B releases the connection.

In step 1943, the Usim2 indicates the release.

In step 1944, the UE assistance Information indicates releasing the capability/configuration limitation.

In step 1945, the RAN node deletes the stored capability/configuration limitation Information and may trigger the reconfiguration procedure.

Discontinuous Reception (DRX) Coordination

The DRX coordination may be a little different from the other capabilities, for that the DRX may be configured separately at multiple networks.

The present disclosure describes various embodiment for the networks aligning the DRX configure as much as possible for the UE power saving purpose.

In one implementation, the UE sends assistance information to the second network, so that the second network determines whether to align a discontinuous reception configuration (DRX-Config) based on the assistance information.

In another implementation, the assistance information comprises a DRX-Config information of the first network.

In another implementation, the UE sends second assistant information to the first network, the second assistance information comprises a DRX-Config information of the second network.

For example, the UE indicates the DRX-Config Info of network A to the network B; and it is left to the network B to decide whether or not to align DRX configuration.

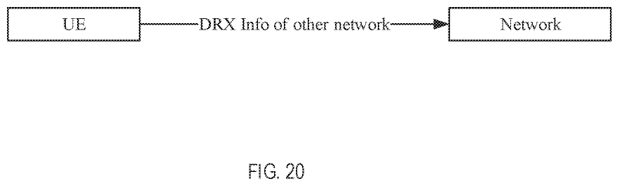

For one example, referring to FIG. 20, the UE sends the DRX information of another network to one network.

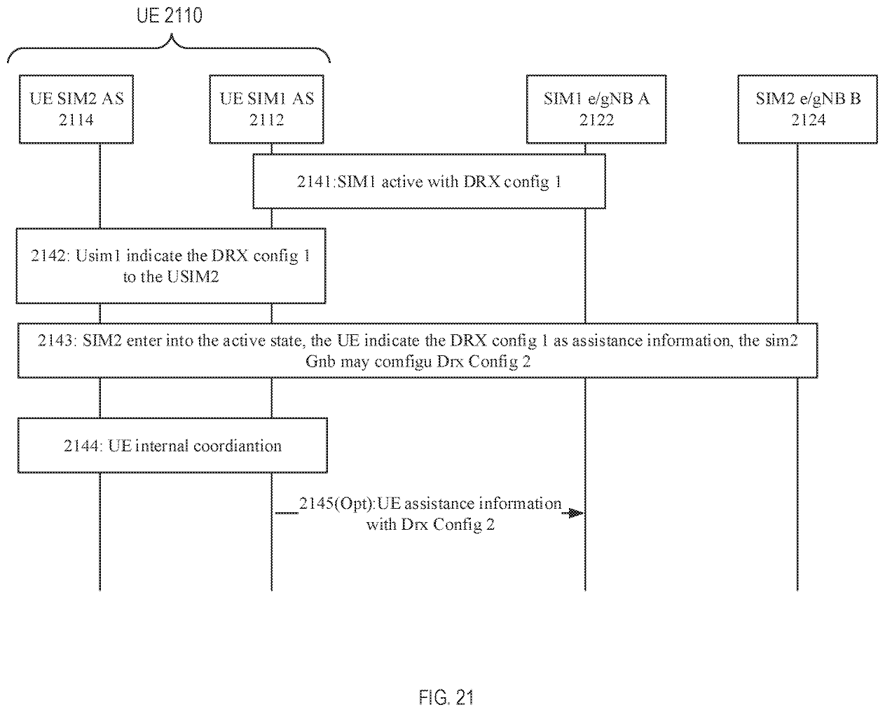

FIG. 21 describes a flow schematic diagram for detail procedure for DRX coordination. The UE 2110 may include a SIM1 access stratum (AS) 2112 and a SIM2 AS 2114. The network A may be SIM1 e/gNB A 2122. The network B may be a SIM2 e/gNB B 2124.

In step 2141, the SIM1 is active with DRX config 1.

In step 2142, the Usim1 indicates the DRX config 1 to the USIM2.

In step 2143, the SIM2 enters into the active state, the UE indicates the DRX config 1 as assistance information, the SIM2 gNB may configure Drx Config 2.

In step 2144, the UE performs internal coordination.

In step 2141, optionally, the UE sends assistance information with Drx Config 2.

Table 1 shows detail information for DRX coordination:

TABLE 1
DRX Info for DRX coordination

| | |
|---|---|
| DRX-Info ::= | SEQUENCE { |
| drx-LongCycleStartOffset | CHOICE { |
| ms10 | INTEGER(0..9), ... }, |
| shortDRX | SEQUENCE { |
| drx-ShortCycle | ENUMERATED {ms2, ms3, |
| | ms4, ms5, ms6, ms7, ms8, ms10, ms14, ms16, |
| | ms20, ms30, ms32, ms35, ms40, ms64, ms80, |
| | ms128, ms160, ms256, ms320, ms512, ms640, |
| | spare9, spare8, spare7, spare6, spare5, spare4, |
| | spare3, spare2, spare1 }, |
| drx-ShortCycleTimer | INTEGER (1..16) |

```
    } OPTIONAL}
drx-onDurationTimer CHOICE {
        subMilliSeconds INTEGER (1..31),
        milliSeconds ENUMERATED {ms1, ms2, ms3, ms4, ms5, ms6, ms8,
ms10, ms20, ms30, ms40, ms50, ms60,ms80, ms100, ms200, ms300, ms400, ms500,
ms600, ms800, ms1000, ms1200,ms1600, spare8, spare7, spare6, spare5, spare4,
spare3, spare2, spare1 } }}
```

### Capability Coordination

In various embodiments, when the UE supports the dual active on both the network A and the network B, the UE may report both the UE capability and the assistance information. In the assistance information, it can include the feature set information.

In one implementation, the UE determine the BC and/or feature set restriction info for the network A based on the UE capability and the current working band of the Network B and send it to the network A as assistance information.

In another implementation, the BC and/or feature set restriction info may include at least one of: explicitly band combinations, feature set combinations, feature set; BC index, FeturesetCombination ID, FeatureSetId that has been send to the UE; and/or any combination of the above with some limitations, e.g., maximum CCs, maximum MIMO layer, maximum modulation order.

In another implementation, upon receiving the assistance information, the network A releases the SCG if have.

In another implementation, upon receiving the assistance information, the network A determines the final CA or single Carrier configuration based on the BC and/or feature set restriction info, then sends the Reconfigure message to the UE.

In another implementation, the UE determines the BC and/or feature set restriction info for the network B based on the UE capability and the current configuration of the Network A and sends it to the network B as assistance information.

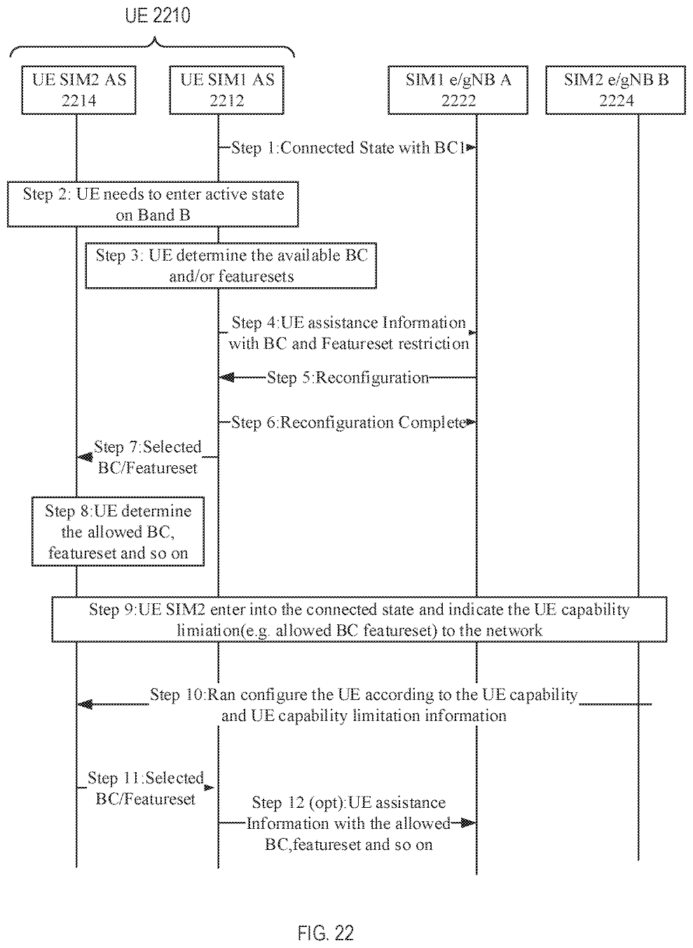

For one example, FIG. 22 shows a general procedure of BC and Feature set cooperation for USIM2 entering into connected state. The UE 2210 may include a SIM1 access stratum (AS) 2212 and a SIM2 AS 2214. The network A may be SIM1 e/gNB A 2222. The network B may be a SIM2 e/gNB B 2224.

Step 1: the UE SIM1 is in a connected State with BC1.

Step 2: the UE needs to enter active state on Band B.

Step 3: the UE determines the available BC and/or featuresets for the network A based on the UE capability and the current working band of the Network B.

Step 4: the UE assistance Information with BC and Featureset restriction.

Step 5: Reconfiguration, the network A releases the SCG (if have) and determines the final CA or single Carrier configuration, then send the Reconfigure message to the UE. The network A store the BC and Featureset restriction.

Step 6: Reconfiguration Complete.

Step 7: for selected BC/Featureset, the UE SIM1 indicates the USIM2 selected BC and featureset information.

Step 8: the UE determines the allowed BC, featureset and so on.

Step 9: the UE SIM2 enters into the connected state and indicates the UE capability limitation (e.g., allowed BC featureset) to the network.

Step 10: the network B configures the UE according to the UE capability and UE capability limitation information. The network B stores the BC and Featureset restriction.

Step 11: for selected BC/Featureset, the UE SIM2 indicates the Usim1 selected BC and featureset information and the UE determines whether it will affect the BC and Featureset restriction that has been sent to the network, if affect go to step 12, otherwise the procedure end.

Step 12: optionally, the UE sends assistance Information with the updated BC and Featureset restriction.

In another implementation, the above Step 3˜Step 7 may be optional when the UE is at CA/Single CC with network A. In another implementation, in the above step 3-5, the UE may determine the available BCs and/or featuresets (or featuresetCombinations) based on the working band info of the network 2.

In another implementation, the Network 1 may be either the Eutra or the NR.

For the Eutra: if the UE has not reported the MR-DC capability (the network didn't require the MR-DC capability or the bands were not included in the filter) to the network, the UE can indicate the BC index. (In the legacy LTE UE capability structure, the BC and BPC were not decoupled); and/or if the UE has reported the MR-DC capability and the network 2 is NR, the UE Can also indicate the allowed BC list and the corresponding featuresetentries, which is similar to the restriction info in the SCG-Config-Info.

For the NR: if the network 2 is Eutra, and the UE has not reported the MR-DC capability (the network didn't require the MR-DC capability or the bands were not included in the filter), the UE can report the corresponding NR BC index and the corresponding featuresetentries; if the network 2 is NR but the network has not required the BC for the corresponding band (e.g., Band of the network 2), the UE can report the corresponding NR BC index and the corresponding featuresetentries; and/or if necessary, the UE shall also indicate the MR-DC BC capability.

For another example for another solution, for the cases that the Network A was not work at the Dual connection state and the current Network A BC/FeatureSet configuration is also acceptable, the UE may ignore the step 4˜6 in FIG. 22, and after the USIM2 enter in to the connected state, the UE may determine the allowed BC/Featureset Restriction Info to the network A based on the UE capability and the selected BC/FeatureSet configuration of the network B, and may send this restriction information to the network.

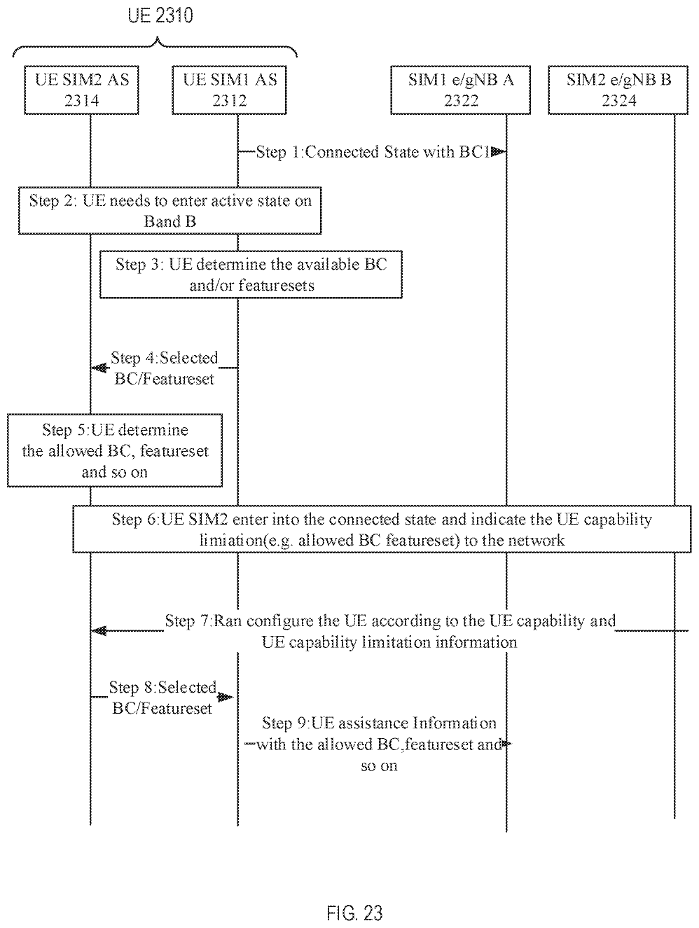

For another example, FIG. 23 shows another procedure of BC and Feature set cooperation for the USIM2 enter into connected state. The UE 2310 may include a SIM1 access stratum (AS) 2312 and a SIM2 AS 2314. The network A may be SIM1 e/gNB A 2322. The network B may be a SIM2 e/gNB B 2324.

Step 1: the UE SIM1 is in a connected State with BC1.

Step 2: the UE needs to enter active state on Band B.

Step 3: the UE determines the available BC and/or featuresets for the network A based on the UE capability and the current working band of the Network B.

Step 4: for selected BC/Featureset, the UE SIM1 indicates the Usim2 selected BC and featureset information.

Step 5: the UE determines the allowed BC, featureset and so on.

Step 6: the UE SIM2 enters into the connected state and indicate the UE capability limitation (e.g., allowed BC featureset) to the network.

Step 7: the network B configures the UE according to the UE capability and UE capability limitation information. The network B stores the BC and Featureset restriction.

Step 8: for selected BC/Featureset, the UE SIM2 indicates the Usim1 selected BC and featureset information and the UE determines the allowed BC and Featureset restriction.

Step 9: the UE sends assistance Information with the allowed BC and Featureset restriction information to the Network A.

The present disclosure describes various embodiments for BC Capability coordination for the modification.

Once the network (e.g., Network A) needs to modify the BC and/or feature set configuration, if the preferred BC and/or feature set configuration is allowed in the stored BC and Featureset restriction information of the network A, the network A may reconfigure the UE with the preferred BC and/or feature set directly.

At the UE side, it may indicate the newly selected BC and/or the feature set, and determines whether it will affect the BC and Featureset restriction that has been sent to the network B, if affect, the UE may send the assistance Information with the updated BC and Featureset restriction to the network B.

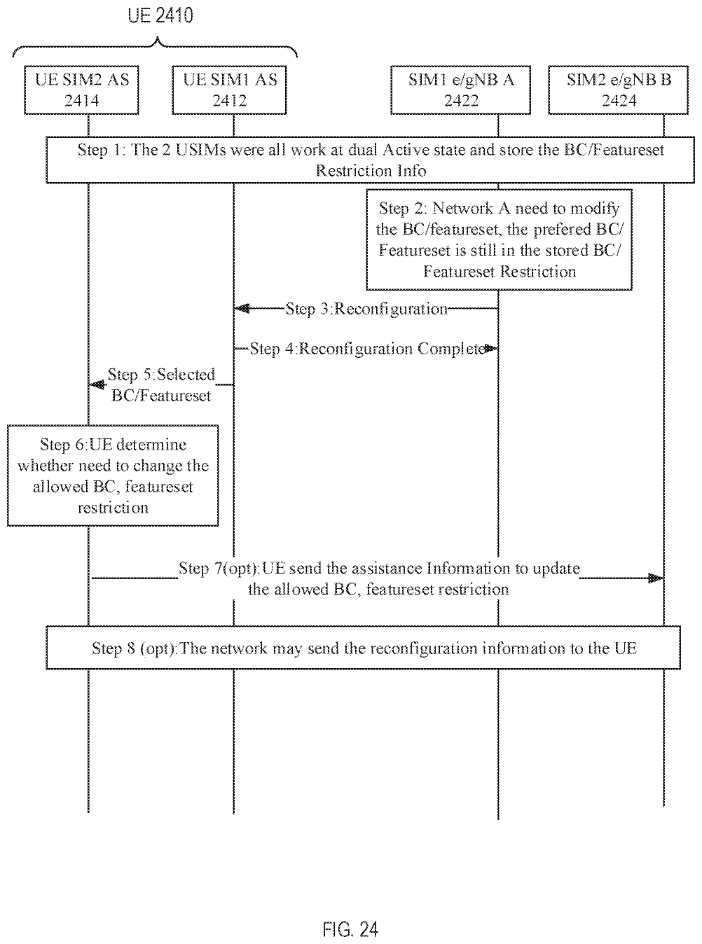

For another example, FIG. 24 shows a general procedure for one USIM configuration modification for BC and/or Featureset. The UE 2410 may include a SIM1 access stratum (AS) 2412 and a SIM2 AS 2414. The network A may be SIM1 e/gNB A 2422. The network B may be a SIM2 e/gNB B 2424.

In one implementation, for the case that the network A want to select the BC/Featureset outside of the stored BC and Featureset restriction, the network need to negotiate with the UE first, the UE may be configured to negotiate with the network B, and determine further action according to the network B's feedback; reject the negotiation directly; or release the network B directly.

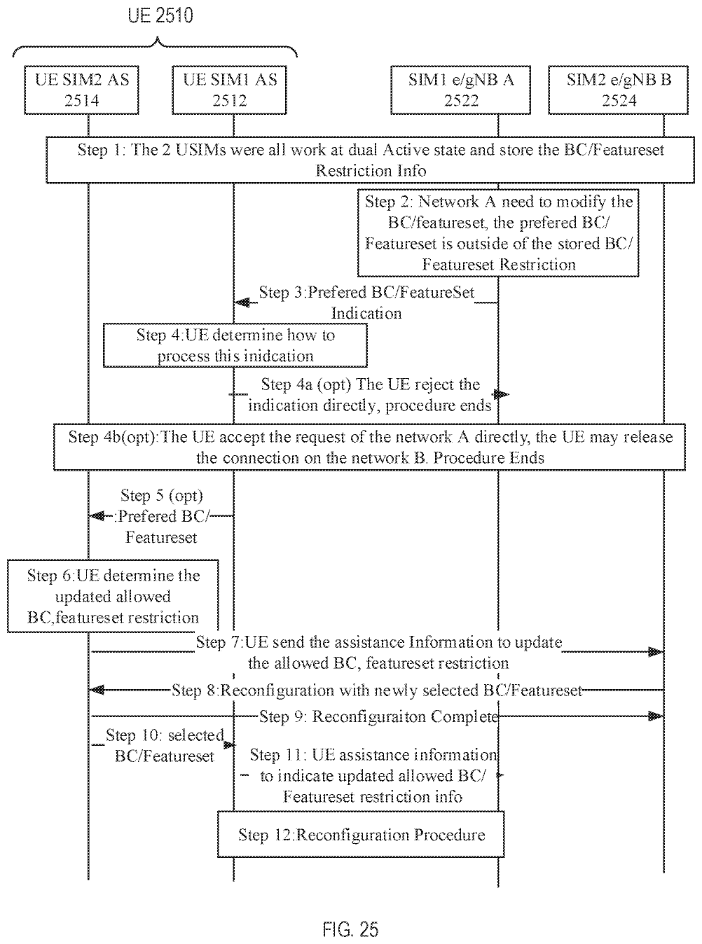

For another example, FIG. 25 shows a general procedure for one USIM configuration modification for BC and/or Featureset. The UE 2510 may include a SIM1 access stratum (AS) 2512 and a SIM2 AS 2514. The network A may be SIM1 e/gNB A 2522. The network B may be a SIM2 e/gNB B 2524.

Step 1: the 2 USIMs work at dual Active state and store the BC/Featureset Restriction Info.

Step 2: the Network A needs to modify the BC/featureset, the preferred BC/Featureset is outside of the stored BC/Featureset Restriction.

Step 3: the preferred BC/FeatureSet Indication.

Step 4: the UE determines how to process this indication.

Step 4a: optionally, the UE rejects the indication directly, procedure ends.

Step 4b: optionally, the UE accepts the request of the network A directly, the UE may release the connection on the network B. Procedure ends.

Step 5: the preferred BC/Featureset.

Step 6: the UE determines the updated allowed BC, featureset restriction.

Step 7: the UE sends the assistance Information to update the allowed BC, featureset restriction.

Step 8: the Reconfiguration with newly selected BC/Featureset.

Step 9: the Reconfiguration Complete.

Step 10: the selected BC/Featureset.

Step 11: the UE sends assistance information to indicate updated allowed BC/Featureset restriction info.

Step 12: the Reconfiguration Procedure.

The present disclosure describes various embodiments for BC Capability coordination for one USIM release.

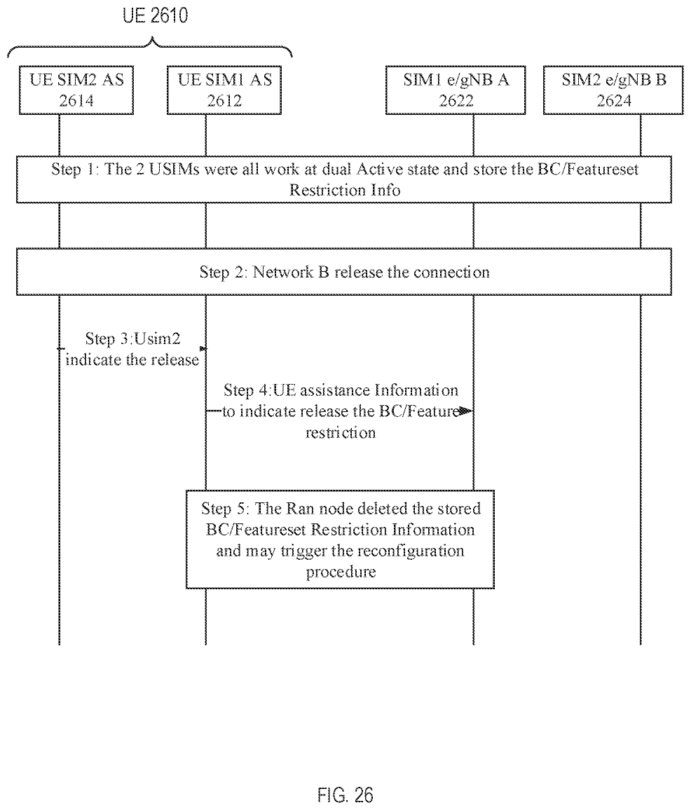

For the dual active state, once one USIM has released the connection, the BC/Featureset Restriction Info on the other USIM is not required. Thus, the UE may send the assistance information to the network as shown in FIG. 26.

Step 1: the 2 USIMs all work at dual Active state and store the BC/Featureset Restriction Info.

Step 2: the Network B releases the connection.

Step 3: the Usim2 indicates the release.

Step 4: the UE sends assistance Information to indicate release the BC/Feature restriction.

Step 5: the RAN node deletes the stored BC/Featureset Restriction Information and may trigger the reconfiguration procedure.

### Measurement Coordination

For the DC, some coordination may be needed between the master node (MN), e.g., the measurement Gap configuration, MN/secondary node (SN) measured frequencies, the maxIntraFreqMeasIdentitiesSCG, maxMeasFreqsSCG, maxInterFreqMeasIdentitiesSCG, maxMeasCLI-ResourceSCG, and/or maxMeasSRS-ResourceSCG.

For the multi-SIM, when the UE wants to share the same RF/Phy resources between the 2 USIMs, the similar limitation and coordination may be needed.

Before the Network 2 sends measConfig to the UE, some limitation that caused by the USIM 1 needs to be informed to the network 2, the procedure may be a little similar to the BC/Featureset coordination, one of the difference may be that for the Measurement Gap, it may be only configured by one network for a Frequency Range. For the case that the UE only supports per UE Gap configuration, the measurement Gap may only be configured at one network for all of the frequency ranges.

The present disclosure describes various embodiments for the UE only supporting per UE gap configuration.

For the UE only supporting per UE gap configuration, the measurement Gap may be only configured at one network. Thus the measurement Gap configuration may take the frequency of the 2 networks, the SMTC for each frequency and the SFTD into the consideration. If one network (e.g., network A) has configured the measurement Gap, the UE needs to send the Measurement Gap configuration and other restriction to the network B.

For one example of solutions, Network 1 determines the MeasConfigRestriction Info, the UE includes the assistance information (e.g., current working band of SIM2) to the network 1, and network 1 determines and feedback the measConfig Restriction info to the UE, then UE indicate the measConfigRestirction Information to the network 2.

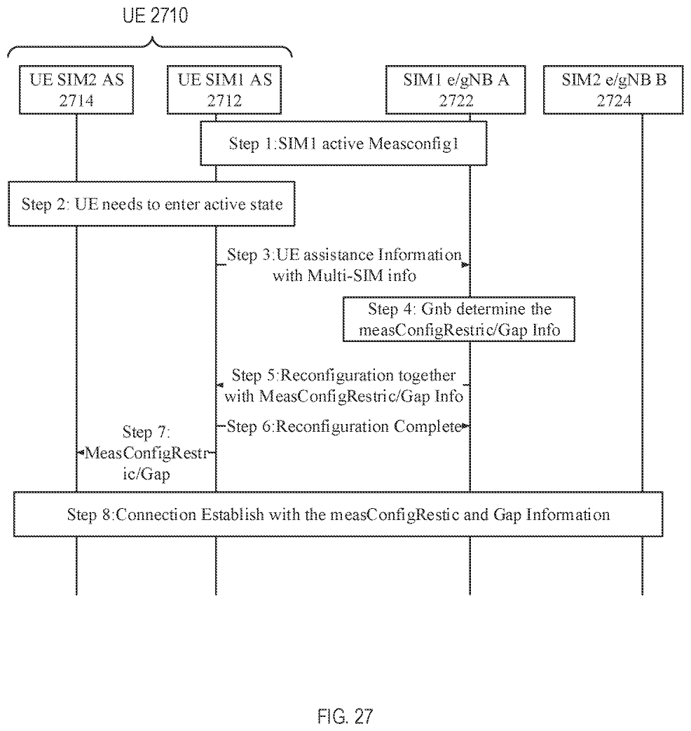

For one example, FIG. 27 shows a general procedure for Measurement Coordination for the USIM2 entering into connected state. The UE 2710 may include a SIM1 access stratum (AS) 2712 and a SIM2 AS 2714. The network A may be SIM1 e/gNB A 2722. The network B may be a SIM2 e/gNB B 2724.

Step 1: the SIM1 is active Measconfig1.

Step 2: the UE needs to enter active state.

Step 3: the UE sends assistance Information with Multi-SIM info. In the assistance information, the UE may indicate the current working band, SMTC of intra-band, SFTD between the serving cell of SIM2 and Serving cell or the pcell of the SIM1, the inter frequency list and the related SMTC info, the UE can get these info from the system Information, which can be taken as the gap pattern selection assistance information.

Step 4: the gNB determines the measConfigRestric/Gap Info, the gNB can determine the Gap config based on the assistance information, meanwhile determines the measConfigRestiction information, such as maxIntraFreqMeasIdentitiesSCG, maxMeasFreqsSCG, maxInterFreqMeasIdentitiesSCG, maxMeasCLI-ResourceSCG, and/or maxMeasSRS-ResourceSCG.

Step 5: for Reconfiguration together with MeasConfigRestric/Gap Info, the networkl sends reconfiguration message with the updated Gap and indicates the MeasConfigRestric info to the UE.

Step 6: for Reconfiguration Complete, the USIM 1 send the complete message to the network 1.

Step 7: for UE internal cooperation, the Usim1 indicates the MeasConfigRestric/Gap information to the USIM2.

Step 8: the Connection Establish with the measConfigRestic and Gap Information, then the network 2 may be restricted the measurement configuration to the measConfigRestic, and the network may avoid the scheduling during the measurement Gap.

When the network B can't accept, the network B may renegotiate with the UE by feedback its preferred Gap and or other restrictions, the UE may send the network B preferred Gap and/or other restrictions to the network A for the negotiation.

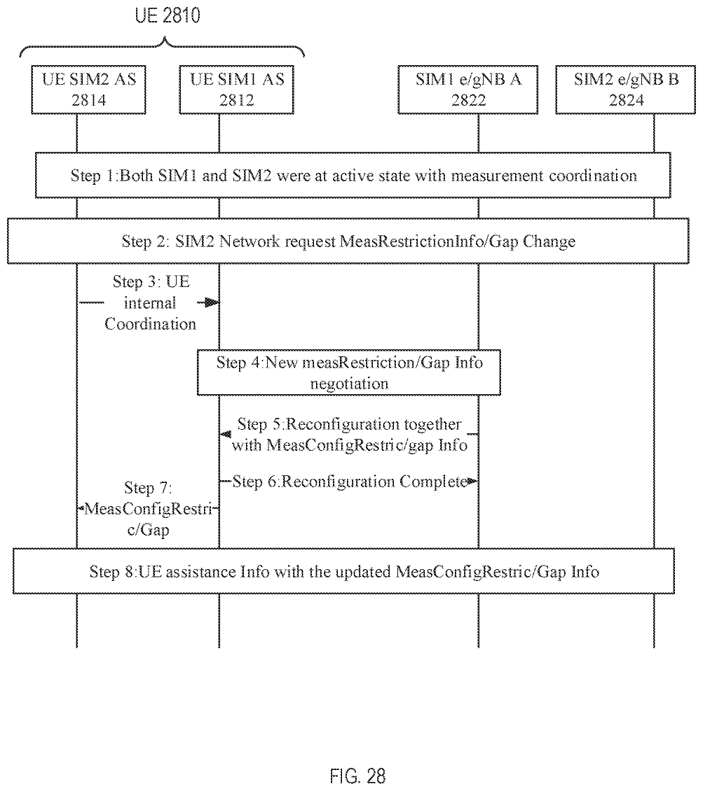

The present disclosure describes various embodiments for renegotiation. For one example, FIG. 28 shows a general procedure for measurement re-negotiation. The UE 2810 may include a SIM1 access stratum (AS) 2812 and a SIM2 AS 2814. The network A may be SIM1 e/gNB A 2822. The network B may be a SIM2 e/gNB B 2824.

Step 1: both SIM1 and SIM2 were at active state with measurement coordination, the measurement Gap was configured at the network A, and both the networks store the measurement restriction information, e.g., maxIntraFreqMeasIdentities, maxMeasFreqs, maxInterFreqMeasIdentities.

Step 2: the SIM2 Network requests MeasRestrictionInfo/Gap Change.

Step 3: the UE internal Coordination, the Usim2 indicates the preferred MeasRestrictionInfo/Measurement Gap, the Usim2 may also provide the frequencies and SMTC information as assistance information of the measurement Gap.

Step 4: for the new measRestriction/Gap Info negotiation, the UE sends the preferred MeasRestrictionInfo/Measurement Gap to the network, the preferred MeasRestrictionInfo/Measurement Gap may be same or different from that in the step 3.

Step 5: the Network A Reconfiguration together with the updated MeasConfigRestric/gap Info.

Step 6: the Reconfiguration Complete.

Step 7: the UE indicates the updated MeasConfigRestric/Gap to the USIM2.

Step 8: the UE sends assistance Info with the updated MeasConfigRestric/Gap Info to the network B.

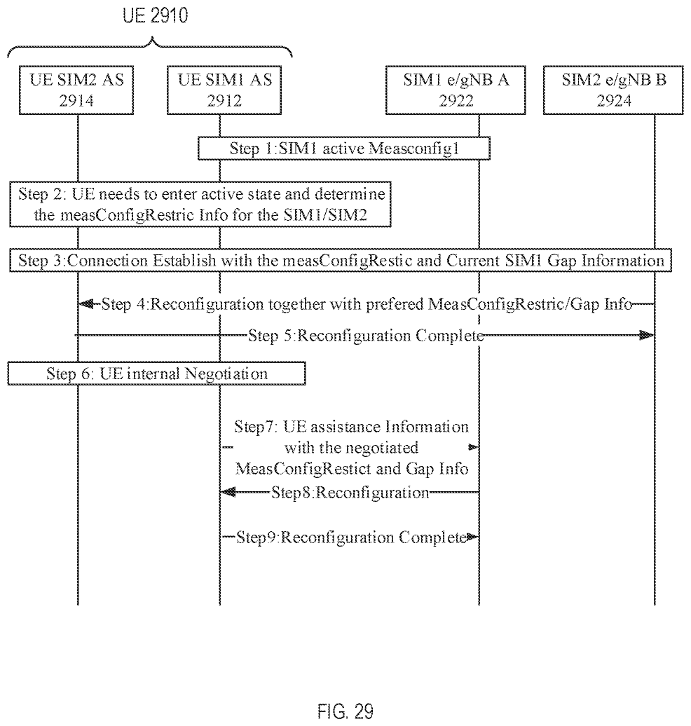

For another example of solutions, the UE determines the restriction info. For the case that the UE does not work at DC state with the network A, and the current measurement Gap info is acceptable, the steps 3-6 in the FIG. 27 4 may be ignored, and the procedure may be as shown in FIG. 29. The UE 2910 may include a SIM1 access stratum (AS) 2912 and a SIM2 AS 2914. The network A may be SIM1 e/gNB A 2922. The network B may be a SIM2 e/gNB B 2924.

Step 1: the SIM1 active with Measconfig1.

Step 2: the UE needs to enter active state and determine the measConfigRestric Info for the SIM1/SIM2.

Step 3: the Connection Establish with the measConfigRestic and Current SIM1 Gap Information.

Step 4: the network B sends Reconfiguration together with preferred MeasConfigRestric/Gap Info to the UE.

Step 5: the UE sends Reconfiguration Complete to the network.

Step 6: the UE performs internal negotiation.

Step 7: the UE sends the assistance Information with the negotiated MeasConfigRestict and Gap Info to the network A. In another implementation, the negotiated MeasConfigRestict and Gap Info maybe different from that in the step 4.

Step 8: the Reconfiguration together with preferred MeasConfigRestric/Gap Info.

Step 9: the Reconfiguration Complete.

The present disclosure describes various embodiments for the UE supporting per FR gap configuration. In NE-DC, the MN indicates the configured per-UE or FR1 measurement gap pattern to the SN. The SN can provide a gap request to the MN, without indicating any list of frequencies.

In NR-DC, the MN indicates the configured per-UE, FR1 or FR2 measurement gap pattern and the gap purpose to the SN. The SN can indicate to the MN the list of SN configured frequencies in FR1 and FR2 measured by the UE.

If the UE supports per FR gap configuration, the measurement Gap for the FR1 may be configured at one Network, while the Gap for the FR2 was configured at the Other Network. It can also be that both FR1 and FR2 gap were configured at one Network, the other network provide frequency/SMTC information to the first network through the UE as assistance information. Anyway the negotiation procedure would be similar to the per UE scenario.

The present disclosure describes various embodiments for measurement coordination for the USIM2 measurement requirement modification. In one implementation, the renegotiation procedure in the FIG. 29 may be adopted for the measurement requirement modification case.

The present disclosure describes various embodiments for measurement coordination for the USIM2 release. In one implementation, it may be similar to the BC capability coordination for the USIM2 release. One of the difference may be that if the Gap was configured previously at the released network/Usim, e.g., network A, the network needs to reconfigure the measurement Gap for network B once receive the related assistance information.

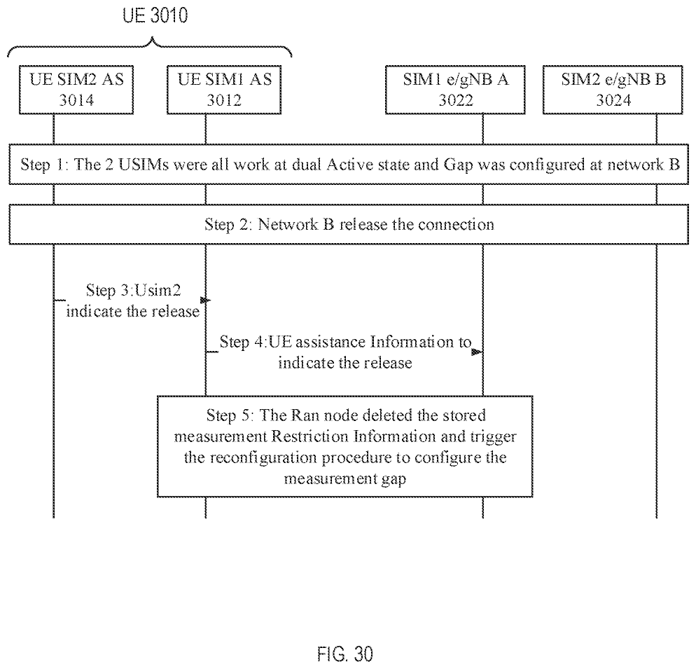

For another example, FIG. 30 shows a general procedure. The UE 3010 may include a SIM1 access stratum (AS) 3012 and a SIM2 AS 3014. The network A may be SIM1 e/gNB A 3022. The network B may be a SIM2 e/gNB B 3024.

Step 1, the 2 USIMs were all work at dual Active state and Gap was configured at network B.

Step 2: the Network B releases the connection.

Step 3: the Usim2 indicates the release.

Step 4: the UE sends assistance Information to indicate the release.

Step 5: the RAN node deletes the stored measurement Restriction Information and triggers the reconfiguration procedure to configure the measurement gap.

The present disclosure describes various embodiments for methods for wireless communication, including coordinating, by a network, multiple networks connecting with a user equipment (UE) by: determining, by the network, configuration parameters or capability restriction; and sending, by the network, the configuration parameters or capability restriction to the UE, the multiple networks comprising a first network and a second network. In one implementation, the method also includes receiving, by the network, multiple network connecting assistance information from the UE.

In another implementation, the multiple network connecting assistance information comprises at least one of the following: a set of configuration parameters or capability restriction of one of the first network or the second network; a set of assistance information of the second network; or a selected configuration of the second network.

In another implementation, the first network is the network receiving the multiple network connecting assistance information.

In another implementation, the set of assistance information including at least one of the following: band information of the second network, or a quality of service (QoS) requirement of the second network.

In another implementation, the configuration parameters or capability restriction determined by the first network comprises at least one of the following: the configuration of the first network; the configuration parameters or capability restriction of the first network; or the configuration parameters or capability restriction of the second network;

In another implementation, in response to receiving a set of configuration parameters or capability restriction for the first network, the first network performs at least one of the following: storing the received set of configuration parameters or capability restriction for the first network; determining a UE configuration of the current network according to the received information; or sending the UE configuration of the current network to the UE.

In another implementation, in response to receiving a set of configuration parameters or capability restriction for the first network, the first network performs at least one of the following: updating the received set of configuration parameters or capability restriction for the first network and storing updated information; determining a UE configuration of the first network according to the updated information; or sending the UE configuration of the current network to the UE.

In another implementation, in response to receiving a set of assistance information of the second network, the first network performs at least one of the following: determining a UE configuration of the first network; determining the configuration parameters or capability restriction of the second network according to the received information; determining and storing the set of configuration parameters or capability restriction for the first network; sending the configuration parameters or capability restriction of the second network to the UE; or sending the UE configuration of the current network to the UE.

In another implementation, in response to receiving a configuration parameters or capability restriction for the second network or the selected configuration of the second network, the first network performs at least one of the following: determining a UE configuration of the first network; determining the configuration parameters or capability restriction of the second network according to the received information; determining and storing the set of configuration parameters or capability restriction for the first network; sending the configuration parameters or capability restriction of the second network to the UE; sending the UE configuration of the current network to the UE; or sending a response message to the UE.

In another implementation, the response message to the UE comprises one of the following: an acceptance indication, a partial acceptance indication, or a rejection indication.

In another implementation, in response to determining an acceptance, the network sends the UE at least one of the following: an accept indication; or an updated set of configuration parameters or the UE capability restriction.

In another implementation, in response to determining a partial acceptance, the network sends the UE an updated set of configuration parameters or the UE capability restriction.

In another implementation, in response to determining a rejection, the network sends the UE the rejection.

In another implementation, the network renegotiates a set of configuration parameters or capability restriction in response to at least one of the following conditions: one of the multiple networks is unable to implement the set of the configuration parameters, or one of the multiple networks needs to modify the set of configuration parameters or capability restriction in response to an event occurring.

In another implementation, the event comprising at least one of the following: a configuration parameters or UE capability negotiation, or a selected set of configuration parameters.

In another implementation, the event comprises at least one of the following: a handover process, a pcell change, or a quality of service (QoS) requirement.

In another implementation, the network receives from the UE one of the following: an acceptance indication, a partial acceptance indication, or a rejection indication.

In another implementation, in response to receiving the partial acceptance indication, the network receives an updated set of configuration parameters from the UE.

In another implementation, the network receives from the UE an assistance information indicating releasing connection with another network; and the network revokes a restriction associated with multiple network connection

In another implementation, the restriction comprises at least one of the following: a capability restriction, or a configuration restriction.

In another implementation, the parameters configuration or the UE capability restriction comprises at least one of the following items: a BC capability configuration or restriction, a power control configuration or restriction, a capability configuration or restriction, or a measurement configuration or restriction.

In another implementation, the BC capability or restriction comprises at least one of the following: a set of band combinations, or a feature set.

In another implementation, the feature set mainly comprises baseband and RF capabilities, comprising at least one of the following: feature set combinations, per feature set capabilities, or per component carrier (CC) per feature set capabilities.

In another implementation, the set of band combinations comprises at least one of the following: a band information, a bandwidth class information, or at least one per band combination parameter.

In another implementation, the power control configuration or restriction comprises at least one of the following: a maximum power of each network, or a maximum power of each frequency range.

In another implementation, the capability configuration or restriction comprises at least one of the following: a maximum number of robust header compression (ROHC), a maximum number of Ethernet header compression (EHC), or a number of blind detections supported.

In another implementation, the measurement configuration or restriction comprises at least one of the following: a measurement gap configuration, at least one measured frequency, a maximum number of inter-frequency carriers allowed to configure, a maximum number of allowed measurement identities allowed to configure for intra-frequency measurement on each serving frequency, or a maximum number of allowed measurement identities allowed to configure for inter-frequency measurement.

In another implementation, the measurement gap configuration comprises at least one of the following: per UE measurement gap configuration, or per frequency measurement gap configuration.

In another implementation, the network receives assistance information from the UE; and the network determines whether to align a discontinuous reception configuration (DRX-Config) based on the assistance information.

In another implementation, the assistance information comprises a DRX-Config information of another network.

The present disclosure describes methods, apparatus, and computer-readable medium for wireless communication. The present disclosure addressed the issues with coordinating multiple networks in dual-active state. The methods, devices, and computer-readable medium described in the present disclosure may facilitate the performance of wireless transmission between a user equipment and multiple network nodes, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
coordinating, by a user equipment (UE), multiple networks comprising a first network and a second network,
wherein the UE coordinates the multiple networks with at least one of the following items:
a band combination (BC) capability coordination,
a power control coordination,
a capability coordination, or
a measurement coordination.

2. The method according to claim 1, wherein:
the UE comprises multiple subscriber identification modules (Multi-SIMs) connecting with the multiple networks;
the UE is in a roaming state connecting with the multiple networks for different slices; or
the UE has a video, imaging, and audio for professional application (VIAPA) connecting with the multiple networks.

3-6. (canceled)

7. The method according to claim 1, wherein:
in response to the UE being at a dual connection (DC) with the first network and the UE wanting to connect with the second network:
the UE indicates the first network to release a second cell group (SCG).

8. The method according to claim 1, wherein:
the BC capability coordination comprises at least one of the following:
a set of band combinations, or
a feature set.

9. The method according to claim 8, wherein:
the feature set mainly comprises baseband and RF capabilities, the feature set comprising at least one of the following:
at least one feature set combination,
at least one per feature set capability, or
at least one per component carrier (CC) per feature set capabilities.

10. The method according to claim 8, wherein:
the set of band combinations comprises at least one of the following:
a band information,
a bandwidth class information, or
at least one per band combination parameter.

11. The method according to claim 1, wherein:
the power control coordination comprises at least one of the following:
a maximum power of each network, or
maximum power of each frequency range.

12. (canceled)

13. The method according to claim 1, wherein:
the measurement coordination comprises at least one of the following:
a measurement gap configuration,
at least one measured frequency,
a maximum number of inter-frequency carriers allowed to configure,
a maximum number of allowed measurement identities allowed to configure for intra-frequency measurement on each serving frequency, or
a maximum number of allowed measurement identities allowed to configure for inter-frequency measurement.

14. The method according to claim 13, wherein:
the measurement gap configuration comprises at least one of the following:
a per UE measurement gap configuration, or
a per frequency measurement gap configuration.

15. The method according to claim 1, wherein:
the UE determines a set of configuration parameters or capability restriction for coordinating the multiple networks; and
the UE sends the set of configuration parameters or capability restriction to the multiple networks.

16-28. (canceled)

29. The method according to claim 1, wherein:
in response to releasing a connection with the first network, the UE sends an assistance information to the second network to revoke a restriction associated with multiple networks connection.

30. The method according to claim 29, wherein:
the restriction comprises at least one of the following:
a capability restriction, or
a configuration restriction.

31-33. (canceled)

34. A method for wireless communication, comprising:
coordinating, by a network, multiple networks connecting with a user equipment (UE) by:
receiving, by the network, multiple network connecting assistance information from the UE;
determining, by the network, configuration parameters or capability restriction; and
sending, by the network, the configuration parameters or capability restriction to the UE, the multiple networks comprising a first network and a second network.

35. (canceled)

36. The method according to claim 34, wherein:
the multiple network connecting assistance information comprises at least one of the following:
a set of configuration parameters or capability restriction of one of the first network or the second network;
a set of assistance information of the second network; or
a selected configuration of the second network, and
wherein:
the first network is the network receiving the multiple network connecting assistance information, and
the set of assistance information including at least one of the following:
band information of the second network, or
a quality of service (QoS) requirement of the second network.

37-52. (canceled)

53. The method according to claim 34, wherein:
the network receives from the UE an assistance information indicating releasing connection with another network; and
the network revokes a restriction associated with multiple network connection

54. The method according to claim 53, wherein:
the restriction comprises at least one of the following:
a capability restriction, or
a configuration restriction.

55-66. (canceled)

67. An apparatus comprising:
a memory storing instructions; and
a processor in communication with the memory, wherein, when the processor executes the instructions, the processor is configured to cause the apparatus to perform coordinating multiple networks comprising a first network and a second network, wherein the apparatus coordinates the multiple networks with at least one of the following items:
a band combination (BC) capability coordination,
a power control coordination,
a capability coordination, or
a measurement coordination.

68. The apparatus according to claim 67, wherein:
the apparatus comprises multiple subscriber identification modules (Multi-SIMs) connecting with the multiple networks;
the apparatus is in a roaming state connecting with the multiple networks for different slices; or
the apparatus has a video, imaging, and audio for professional application (VIAPA) connecting with the multiple networks.

69. An apparatus comprising:
a memory storing instructions; and
a processor in communication with the memory, wherein, when the processor executes the instructions, the processor is configured to cause the apparatus to perform coordinating multiple networks connecting with a user equipment (UE) by:
receiving multiple network connecting assistance information from the UE;
determining configuration parameters or capability restriction; and
sending the configuration parameters or capability restriction to the UE, the multiple networks comprising a first network and a second network.

70. The apparatus according to claim 69, wherein:
the multiple network connecting assistance information comprises at least one of the following:
a set of configuration parameters or capability restriction of one of the first network or the second network;
a set of assistance information of the second network; or
a selected configuration of the second network, and
wherein:
the first network is the network receiving the multiple network connecting assistance information, and
the set of assistance information including at least one of the following:
band information of the second network, or
a quality of service (QoS) requirement of the second network.
